(19) United States
(12) Patent Application Publication
(10) Pub. No.: US 2006/0214031 A1
(43) Pub. Date: Sep. 28, 2006

(54) Water spray nozzle

(75) Inventors: Hideki Kawakami, Chiba-shi (JP); Yoshio Kaji, Tokyo (JP); Hiromitsu Kurita, Narita-shi (JP)

Correspondence Address: ST. ONGE STEWARD JOHNSTON & REENS, LLC, 986 BEDFORD STREET, STAMFORD, CT, 06905-5619, US

(73) Assignee: NIPPO CORPORATION

(21) Appl. No.: 11/442,570

(22) Filed: May 26, 2006

Related U.S. Application Data
(63) Continuation of application No. PCT/JP04/17770, filed on Nov. 30, 2004.

(30) Foreign Application Priority Data
Dec. 2, 2003 (JP) 2003-403215

(51) Int. Cl. B05B 1/34

(52) U.S. Cl. 239/493

(57) ABSTRACT

A water spray nozzle has a body of which an inner peripheral flange is provided on the upper end thereof and a core that is installed in the body and whose outer peripheral edge section of an upper end face is made to be in contact with a lower face of the inner peripheral flange. Grooves for nozzle holes are provided in the outer peripheral edge section of the core, and the grooves are formed at predetermined intervals in the circumferential direction from the outer peripheral side of the core to an opening on the inner peripheral side. Nozzle holes formed by the lower face of the inner peripheral flange and the grooves are each set such that, in a side view, an extension line extended from the axis of a flow path is inclined with the opening side directed upward at a predetermined elevation angle relative to the upper face of the body, and that, in a plan view, the extension line passes a position separated from the center of the core and the extension lines of adjacent flow paths intersect each other at a predetermined intersection angle.

### CROSS-REFERENCE TO RELATED APPLICATIONS

The present application is a continuation of pending International patent application PCT/JP2004/017770 filed on Nov. 30, 2004 which designates the United States and claims priority from Japanese patent application No. 2003-403215 filed on Dec. 2, 2003, the content of which is incorporated herein by reference.

### FIELD OF THE INVENTION

This invention relates to a water spray nozzle which is installed on a road surface and the like of a vehicle running test course in order to reproduce conditions such as rainfall on the road surface and the like.

### BACKGROUND OF THE INVENTION

There are conventional water spray nozzles and water spray nozzles for removing snow which are installed on a road surface of a vehicle running test course and reproduce conditions such as rainfall by spraying water onto the road surface, making it possible to carry out slip tests and performance tests for vehicle tires, vehicle running performance tests, and so on. One such nozzle has a cylindrical nozzle main unit inside which is provided a water-conducting hole connected to a supply pipe, and a disk-shaped lid member which seals the water-conducting hole and is attached in a center of an upper end of the nozzle main unit so as to form fountain holes which join to the water-conducting hole. In this type of nozzle, water is conducted from the supply pipe to the water-conducting hole and ejected from the fountain holes provided around the lid member, whereby water is sprayed diagonally upwards in an emission direction of the nozzle main unit along an upwardly spreading tapered face of a water spray guide section, provided in an upper end outer peripheral section of the nozzle main unit (e.g. see Patent Document 1).

Other conventional nozzles have one having a cylindrical nozzle main unit inside which is provided a water-conducting hole connected to a supply pipe, a nozzle head having a flow chamber which joins to the water-conducting hole and whose upper end is sealed, the nozzle head being attached in a center of an upper end of the nozzle main unit, a plurality of water spray holes which are provided around the nozzle head in the emission direction and are directed diagonally upward; in addition, a water spray guide, in which are provided a plurality of guide grooves whose upper sections are open and which join to outer ends of the water spray holes while inclining in their extension direction, is attached around an outer periphery of the nozzle head, such that water is ejected from the water spray holes in the nozzle head and sprayed diagonally upwards from the emission direction of the nozzle main unit, and one which omits the water spray guide (e.g. see Patent Documents 2 and 3).

[Patent Document 1] Japanese Unexamined Patent Application, First Publication No. H11-131435 (FIGS. 2 to 5)

[Patent Document 2] Japanese Unexamined Patent Application, First Publication No. H07-238520 (FIGS. 1 and 2)

[Patent Document 3] Japanese Unexamined Patent Application, First Publication No. H05-31405 (FIG. 2)

### SUMMARY OF THE INVENTION

Among the conventional water spray nozzle and water spray nozzle for removing snow mentioned above, in those in which the nozzle head is provided with a water spray guide section and those to which a water spray guide is attached, water ejected from the fountain holes and the water spray holes is guided diagonally upward in the emission direction of the nozzle heads by the tapered face of the water spray guide section and the guide grooves of the water spray guide, such that the ejection flow of the water is formed evenly in the emission direction. In reality however, due to changes in the drip state from the fountain holes and the water spray holes for spraying water and such like, the tapered face and the guide grooves become an obstruction which disturbs the ejection flow of the water from the fountain holes and the water spray holes, leading to a danger that it becomes impossible to create sprayed particles evenly on the road surface and the like.

Among the conventional water spray nozzle and water spray nozzle for removing snow mentioned above, in those in which a plurality of fountain holes and water spray holes are arranged in the circumferential direction of the nozzle main unit and directed toward the emission direction, the ejection flows from the fountain holes and the water spray holes become mutually separated as their distances increase, leading to a problem that the road surface and the like is unevenly sprayed and unsprayed portions are created, whereby it is not possible to reproduce a state where the road surface and the like is made evenly wet by rainfall.

The present invention has been realized in view of the problems described above, and aims to provide a water spray nozzle which can spray water evenly onto a running road surface for vehicle and a road surface which requires spraying, and can reliably reproduce a state where the road surface and the like is made wet by rainfall.

### Means for Solving the Problems

In order to solve the above problems, this invention is characterized as follows.

A water spray nozzle of this invention has a cylindrical body on an upper end of which an inner peripheral flange having an opening is provided, and a core which is installed in the body and outer peripheral edge section of an upper end face thereof is made to be in contact with a lower face of the inner peripheral flange; a plurality of grooves for nozzle holes which lead from the outer peripheral side of the core to an inner peripheral side being provided in the outer peripheral edge section of the upper end face of the core.

A plurality of nozzle holes, which are formed by the lower face of the inner peripheral flange and the grooves for nozzle holes, are set such that, in a side view, an extension line extended from the axis of a flow path leading from the outer peripheral side of the core to the opening in the inner peripheral side is inclined with the opening side directed upward at a predetermined elevation angle relative to the upper face of the body, and that, in a plan view, the extension line passes a position separated from the center of the core.

Preferably, the nozzle holes are arranged at predetermined intervals in the circumferential direction of the core.

The extension lines extended from axes of the flow paths of the adjacent nozzle holes may preferably intersect each other at a predetermined intersection angle. More preferably, the intersection angle is between 10° and 30°.

Preferably, the elevation angle of the extension line of the axis of the flow path of the nozzle holes may be between 10° and 25°.

The extension lines extended from the axis of the flow path of each nozzle holes may be tangential to an imaginary circle which is provided the inside of the outer peripheral edge section.

In this invention, the water spray nozzle has a body and a core, and a plurality of the water spray nozzles are connected via a supply pipe or the like to a water-conducting pipe provided along both sides of a road surface of a vehicle running test course or the like. Water supplied into the body from the water-conducting pipe flows in from the lower end of the core, and then from the outer peripheral side of the core into the nozzle holes; the water is ejected from openings thereof in a diagonally upward direction separated from the center of the core and, in a plan view, is sprayed within the range of a circle having the core as its center. By ejecting water from a plurality of water spray nozzles, the entire road surface or the like can be evenly sprayed without creating any unsprayed portions.

The water spray nozzle of this invention may further have an influx path which joins a lower section of the water spray nozzle to the grooves for nozzle hole. Preferably, this influx path includes a ring-shaped groove which is formed in an upper outer periphery of the core and joined to the grooves for nozzle hole, and an influx hole, whose lower end is open to the lower face of the core and whose upper end is joined to the ring-shaped groove, being provided in the core.

The core may be detachably installed in the body by screwing a male screw provided in the outer periphery of the core into a female screw provided in the inner periphery of the body, and a slit for rotating the core with respect to the body may be provided along the diameter direction of the core in the upper end face thereof.

The present invention obtains the following advantageous effects.

Since the plurality of nozzle holes are set such that, in a side view, the extension line extended from the axis of the flow path leading from the outer peripheral side of the core to the opening in the inner peripheral side is inclined with the opening side directed upward at a predetermined elevation angle relative to the upper face of the body, and that, in a plan view, the extension line passes a position separated from the center of the core and the extension lines of adjacent flow paths intersect each other at a predetermined intersection angle, water is ejected from the openings of the nozzle holes in a rod-like spray and there is no interference between adjacent sprays near the openings and thereby no disturbance occurs in the flow. By making adjacent water sprays closer to each other, the intervals between water sprays which are ejected to a far distance can be made as small as possible. Therefore, unevenness in the sprayed portion, and creation of unsprayed portions, of the road surface and the like can be prevented, the water can be sprayed such that sprayed particles are created evenly over the road surface and the like, and a state where the road surface and the like has been made wet by rainfall can be reliably reproduced. Moreover, since the simple configuration includes two components, a body and a core, it has no drive section and does not break down.

According to the water spray nozzle of this invention, water which is conducted from the influx hole of the core to the ring-shaped groove is speedily distributed by the ring-shaped groove to the nozzle holes arranged along the outer periphery of the core, enabling the water to be sprayed evenly from the nozzle holes.

According to the water spray nozzle of this invention, by inserting a tool into the slit for attaching/removing the core in the upper end face of the core and rotating the core, the core can be loosened so that the grooves of the core are separated from the lower face of the inner peripheral flange of the body, whereby extraneous particles, dirt, and the like which have become stuck in the nozzle holes can be removed precisely by cleaning.

### BRIEF DESCRIPTION OF THE DRAWINGS

FIG. 1 is a plan view showing a water spray nozzle according to an embodiment of this invention.

FIG. 2 is a vertical cross-sectional view showing a water spray nozzle according to an embodiment of this invention;

FIG. 3 is a plan view showing a core of a water spray nozzle according to an embodiment of this invention.

FIG. 4 is a plan view showing a road surface installation state of a water spray nozzle according to an embodiment of this invention.

### DETAILED DESCRIPTION OF THE INVENTION

A water spray nozzle according to an embodiment of this invention will be explained with reference to the drawings.

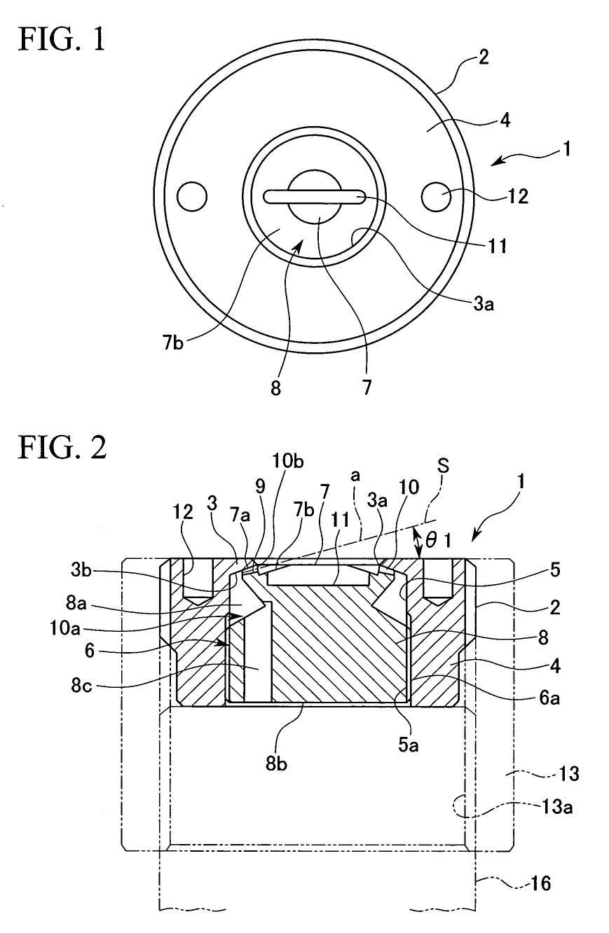

In FIGS. 1 to 3, reference symbol 1 represents a water spray nozzle according to an embodiment of this invention. The water spray nozzle 1 includes a cylindrical body 4 and a circular-column core 8. A male screw 2 is formed in an outer peripheral section of the body 4, which is provided with a ring-shaped inner peripheral flange 3 whose upper end has a circular opening 3a. The core 8 is inserted into the body 4 by screwing a male screw 6a of an outer peripheral section 6 into a female screw 5a formed in an inner peripheral section 5 of the body 4, and an outer peripheral edge section 7a of an upper end face 7 is made to be in contact with a lower face 3b of the inner peripheral flange 3 of the body 4.

The lower face 3b of the inner peripheral flange 3 of the body 4 is formed as an inclining face such that the opening 3a side (inner peripheral side) inclines upward. The outer peripheral edge section 7a of the upper end face 7 of the core 8 is also formed as an inclining face which is aligned with the gradient of the lower face 3b of the inner peripheral flange 3, and, when the outer peripheral edge section 7a of the upper end face 7 of the core 8 is made to contact the lower face 3b of the inner peripheral flange 3, the upper end face 7 of the core 8 is slightly lower than the upper end face of the body 4. In the upper end face 7 of the core 8, a ring-shaped recess 7b is provided on the inner side of the outer peripheral edge section 7a which contacts the inner peripheral flange 3. A bottom face of the recess 7b has the same gradient as the inclining face of the outer peripheral edge section 7a.

A ring-shaped groove 8a is triangular in a cross-sectional view and is provided in the upper end side of the outer peripheral section 6 of the core 8. The ring-shaped groove 8a faces in an up-down direction inside the core 8, and joins to an upper end of an influx hole 8c which opens to a lower end face 8b of the core 8. A plurality of grooves for nozzle holes 9, which are rectangular in a cross-sectional view and join the ring-shaped groove 8a of the core 8 to the ring-shaped recess 7b, are provided in the outer peripheral edge section 7a of the upper end face 7 of the core 8 at equal intervals along a definite range in the circumferential direction of the core 8, through the inner and outer peripheries of the outer peripheral edge section 7a. For example, each groove 9 is rectangular in a cross-sectional view, having a width of 0.8 mm and a depth of 0.9 mm, and eleven grooves 9 are provided along the range of a half-periphery (180°), forming water nozzle holes 10 together with the lower face 3b of the inner peripheral flange 3 of the body 4. The nozzle holes 10 are open toward the opening 3a (recess 7b) side of the inner peripheral flange 3. The ring-shaped groove 8a and the influx hole 8c form an influx path 10a which joins to the nozzle holes 10 and supplies water for spraying to them. A bottom of the recess 7b is deeper than the bottoms of the grooves 9.

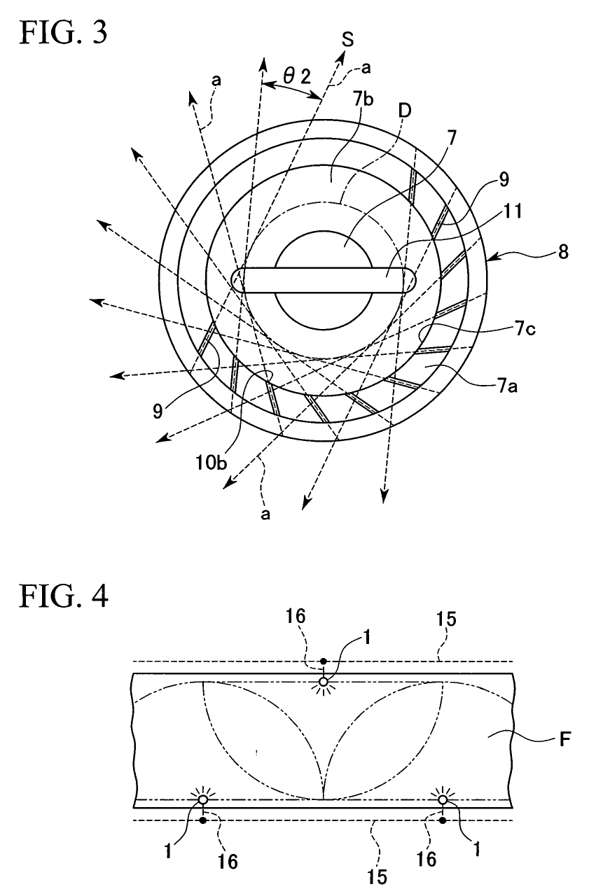

The direction of a central axis line (an extension line extended from the axial line of the flow path of the nozzle hole 10) S of the nozzle hole 10 is set at an angle equal to the gradient of lower face 3b of the inner peripheral flange 3 of the body 4 and the outer peripheral edge section 7b of the upper end face 7 of the core 8, and is inclined at an elevation angle θ1 relative to the upper end face of the body 4 and the upper end face 7 of the core 8 or a plane parallel to them, with the opening side of the nozzle holes 10 directed upward. The direction of the central axis lines S of the nozzle holes 10, when seen in a plan view from above the core 8 (FIG. 3), are arranged on a tangent which is tangential to an imaginary circle D (whose center is identical with the center of the core 8) provided further to the inside than an inner end 7c (outer end of the recess 7b) of the outer peripheral edge section 7a of the core 8, and lines S of adjacent nozzle holes 10 intersect each other at an intersection angle θ2. That is, the nozzle holes 10 are provided such that, in a plan view, their openings 10b face in a direction separated from the center of the core 8.

While the elevation angle θ1 of the nozzle holes 10 differs according to the diameter and the like of the core 8, it is set at between 10° and 25° (15° in the example of the drawings), and the intersection angle θ2 the nozzle holes 10 is set at, for example, between 10° and 30° (20° in the example of the drawings).

A slit (slit for attaching/removing core) 11 is provided in the center of the upper end face 7 of the core 8 formed along the diameter direction of the core 8. By inserting a tool into the slit 11 and rotating the core 8 with respect to the body 4, the screwed section of the female screw 5a of the body 4 and the male screw 6a of the core 8 can be tightened and loosened, enabling the core 8 to be attached and removed to/from the body 4. Tool holes 12 are provided in the top end face of the body 4 at two positions in the diameter direction. By inserting a suitable tool into the tool holes 12 and rotating the water spray nozzle 1, the water spray nozzle 1 can be connected by screwing to a connection tube 13.

The water spray nozzle 1 having the above configuration is connected by screwing the body 4 to the connection tube 13. As shown in FIG. 4, the connection tube 13 is connected via male screws 1 3a thereof to supply pipes 16 which are connected at predetermined intervals along water-conducting pipes 15 provided on both sides of a running path F of a vehicle running test course or the like. The water spray nozzle 1 is arranged in a path side section such that the upper end face of the body 4 is flush with the surface of the running path F, with the openings 10b of the nozzle holes 10 directed toward the running path F sides. In this case, installation positions in the longitudinal direction of the running path F of the water spray nozzles 1 and 1 on both sides of the running path F are deviated in the direction of the running path F by one-half of the relative distance between adjacent water spray nozzles 1 and 1, and face each other diagonally with the running path F therebetween. As mentioned above, when the upper end face of the body 4 is arranged so as to be flush with the surface of the running path F, since no members protrude from the upper end face of the body 4, even if a vehicle running along the path side sections treads on the water spray nozzle 1, there is no damage and the running of the vehicle is not impeded.

When using the water spray nozzle 1, water for spraying is supplied from the water-conducting pipe 15 via the supply pipe 16 and the connection tube 13 to the lower end of the core 8, and flows via the influx path 10a (the influx hole 8c and the ring-shaped groove 8a) to the nozzle holes 10. The water for spraying which flows to the nozzle holes 10 becomes a rod-like spray (ejection flow) “a” which is ejected from the openings 10b and sprayed within a semicircular range onto the running path F. In this case, since the water spray nozzles 1 installed on both side sections are arranged in zigzags each other as described above, the spray range of the water sprayed within the semicircular range overlaps in plan view, and there is no portion on the running path F where water is not sprayed. Since the water ejected in a rod-like spray “a” from the nozzle holes 10 has a large particle diameter, even if there is a slight wind, the water is not carried by the wind and no unevenness occurs. Although adjacent sprays “a” intersect each other in plan view, they do not intersect in the vertical direction, ensuring that there is no disturbance caused by mutual interference and allowing them to reach a long distance.

For example, when the elevation angle θ1 and the intersection angle θ2 of the nozzle holes 10 are respectively set at 15° and 20° as described above, the spraying angle is set at 180°, the supply water pressure at 0.2 MPa, and the flow amount in the nozzle holes 10 at 5.5 L/min, the sprays “a” can be sprayed evenly over a semi-circular spraying face with a radius of 4000 mm to a maximum spray height of 500 mm.

In order to spray the water evenly onto the running path F without causing unevenness, the elevation angle θ1 and the intersection angle θ2 of the nozzle holes 10 may preferably be set within predetermined numerical ranges.

When the elevation angle θ1 of the nozzle holes 10 exceeds its upper limit of 25°, the spray height is too high, and impedes the vision of the driver of the vehicle; when the elevation angle θ1 is below the lower limit of 10°, the sprays a from adjacent nozzle holes 10 interfere with each other in the vertical direction, making it difficult to spray the water evenly onto the running path F.

When the intersection angle θ2 of the nozzle holes 10 exceeds its upper limit of 30°, the intervals between the nozzle holes 10 are too wide and it becomes difficult to spray water onto some parts of the running path F, whereby an even spray cannot be expected. When the intersection angle θ2 of the nozzle holes 10 is below its lower limit of 10°, the sprays “a” from the nozzle holes 10 interfere with each other and become disturbed, leading to a danger of insufficient spray height and unevenness in the spray.

When the water spray nozzle 1 has been used for a fixed period of time, the core 8 is loosened by inserting a tool into the slit 11 and rotating the core 8, thereby separating the grooves 9 of the core 8 from the lower face 3b of the inner peripheral flange 3 of the body 4; the grooves 9 are then inspected and, if any extraneous particles or the like has become stuck in the nozzle holes 10, it is removed by cleaning.

According to the water spray nozzle 1, the plurality of nozzle holes 10 formed by the lower face 3b of the inner peripheral flange 3 and the grooves 9 are each set such that, in a side view, the extension line S extended from the axis of the flow path which leads from the outer peripheral side of the core 8 to the opening in the inner peripheral side is inclined with the opening 10b side directed upward at the predetermined elevation angle θ1 relative to the upper face of the body 4, and that, in a plan view, the extension line S passes a position separated from the center of the core 8 and lines S of the axes of adjacent flow paths intersect each other at the predetermined intersection angle θ2; therefore, adjacent rod-like sprays “a” ejected from the openings 10b of the nozzle holes 10 do not interfere with each other near the opening and become disturbed, and adjacent water sprays “a” are made closer to each other, whereby the interval between sprays “a” and “a” which are ejected to a far distance can be reduced, and sprayed particles can be created evenly over the running path F and the like without unevenness in the water spray portion of the running path F and the like and without causing portions which are not sprayed, making it possible to reliably reproduce a state where the running path F and the like has been made wet by rainfall. Moreover, since the water spray nozzle 1 has a simple configuration of two components of a body and a core, it has no drive section and does not break down.

The influx path 10a of the core 8 includes the ring-shaped groove 8a which is formed in the upper sectional outer periphery of the core 8 and joins to the grooves 9, and the influx hole 8c which is provided in the core 8 such that its lower end is open to the lower face of the core 8 and its upper end is joined to the ring-shaped groove 8a; therefore, water for spraying which is fed from the influx hole 8c of the core 8 to the ring-shaped groove 8a is speedily distributed by the ring-shaped groove 8a to the nozzle holes 10 arranged along the outer periphery of the core 8, achieving an even spray “a” from each of the nozzle holes 10.

The core 8 is removed and attached to/from the body 4 by screwing the male screw 6a provided around its outer periphery into the female screw 5a provided in the inner periphery of the body 4, and the slit 11 for rotating the core 8 with respect the body 4 is provided along the diameter direction of the core 8 in the upper end face 7 of the core 8. By inserting a tool into the slit 11 and rotating the core 8, the core 8 is loosened and the grooves 9 of the core 8 are separated from the lower face 3b of the inner peripheral flange 3 of the body 4, extraneous particles and the like which are stuck in the nozzle holes 10 can be removed by cleaning and facilitating maintenance.

While in the water spray nozzle 1 described above, eleven nozzle holes 10 are installed along a half-circumference in the circumferential direction of the core 8, the nozzle holes may be installed along the entire circumference of the core 8 or within another angular range thereof, and the number of installation is not limited to eleven, and an appropriate number may be installed in accordance with the installation range etc. The influx hole 8c joining to the ring-shaped groove 8a is also not limited to one, and many holes may be provided. While in this example the water spray nozzles 1 are arranged alternately on both sides of the running path F of a vehicle running test course, when the running path F is wide, water spray nozzles in which the nozzle holes 10 are provided along the entire periphery of the core 8 can be arranged in the center of the running path F in alternate relation to the water spray nozzles 1 on both sides, enabling the entire road surface to be sprayed evenly by these water spray nozzles.

### INDUSTRIAL APPLICABILITY

According to the water spray nozzle of this invention, a plurality of nozzle holes are each set such that, in a side view, a extension line extended from the axis of the flow path which leads from the outer peripheral side of the core to an opening in the inner peripheral side is inclined with the opening side directed upward at the predetermined elevation angle relative to the upper face of the body, and that, in a plan view, the extension line passes a position separated from the center of the core and the extension lines of the axes of adjacent flow paths intersect each other at the predetermined intersection angle; therefore, adjacent rod-like sprays from the openings of the nozzle holes do not interfere with each other near the opening and become disturbed. Furthermore, adjacent water sprays are made closer to each other, enabling the intervals between sprays which are sprayed far to be reduced. Therefore according to the water spray nozzle of this invention, water can be sprayed such that sprayed particles are created evenly over the road surface and the like without unevenness in the water spray portion of the road surface and the like and without causing portions which are not sprayed, whereby a state where the road surface and the like has been made wet by rainfall can be reliably reproduced. Moreover, since the water spray nozzle has a simple configuration of two components, a body and a core, it has no drive section and does not break down.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A water spray nozzle comprising:
a cylindrical body on an upper end of which an inner peripheral flange having an opening is provided; and
a core which is installed in the body and an outer peripheral edge section of an upper end face thereof is made to be in contact with a lower face of the inner peripheral flange, wherein
a plurality of grooves for nozzle hole, which lead from the outer peripheral side of the core to an inner peripheral side being provided in the outer peripheral edge section of the upper end face of the core; and
a plurality of nozzle holes, which are formed by the lower face of the inner peripheral flange and the grooves for nozzle hole, being set such that, in a side view, a extension line extended from the axis of a flow path leading from the outer peripheral side of the core to an opening in the inner peripheral side is inclined with the opening side directed upward at a predetermined elevation angle relative to an upper face of the body, and that, in a plan view, the extension line passes a position separated from the center of the core.

2. The water spray nozzle according to claim 1, wherein the nozzle holes are arranged at predetermined intervals in the circumferential direction of the core.

3. The water spray nozzle according to claim 1, wherein the extension lines extended from the axes of the flow paths of the adjacent nozzle holes intersect each other at a predetermined intersection angle.

4. The water spray nozzle according to claim 3, wherein the intersection angle is between 10° and 30°.

5. The water spray nozzle according to claim 1, wherein the elevation angle is between 10° and 25°.

6. The water spray nozzle according to claim 1, wherein the extension line extended from the axis of the flow path of each nozzle hole is tangential to an imaginary circle which is provided further to the inside than the outer peripheral edge section.

7. The water spray nozzle according to claim 1, further comprising an influx path which joins a lower section of the water spray nozzle to the grooves for nozzle holes,
the influx path is formed by a ring-shaped groove which is formed in an upper outer periphery of the core and joined to the grooves, and an influx hole, whose lower end is open to a lower face of the core and whose upper end is joined to the ring-shaped groove, being provided in the core.

8. The water spray nozzle according to claim 1, wherein
the core is detachably installed in the body by screwing a male screw provided in the outer periphery of the core into a female screw provided in the inner periphery of the body, and
a slit for attaching and removing the core is provided along the diameter direction of the core in the upper end face thereof for rotating the core with respect to the body.

9. A water spray nozzle comprising:
a cylindrical body on an upper end of which an inner peripheral flange having an opening is provided; and
a core which is installed in the body and an outer peripheral edge section of an upper end face thereof is made to be in contact with a lower face of the inner peripheral flange, wherein
a plurality of grooves for nozzle hole, which lead from the outer peripheral side of the core to an inner peripheral side being provided in the outer peripheral edge section of the upper end face of the core;
a plurality of nozzle holes, which are formed by the lower face of the inner peripheral flange and the grooves for nozzle hole, being set such that, in a side view, a extension line extended from the axis of a flow path leading from the outer peripheral side of the core to an opening in the inner peripheral side is inclined with the opening side directed upward at a predetermined elevation angle relative to an upper face of the body, and that, in a plan view, the extension line passes a position separated from the center of the core;
wherein an influx path which joins a lower section of the water spray nozzle to the grooves for nozzle holes,
the influx path is formed by a ring-shaped groove which is formed in an upper outer periphery of the core and joined to the grooves, and an influx hole, whose lower end is open to a lower face of the core and whose upper end is joined to the ring-shaped groove, being provided in the core;
wherein the core is detachably installed in the body by screwing a male screw provided in the outer periphery of the core into a female screw provided in the inner periphery of the body, and
a slit for attaching and removing the core is provided along the diameter direction of the core in the upper end face thereof for rotating the core with respect to the body.
